(19) United States
(12) Patent Application Publication
(10) Pub. No.: US 2019/0137760 A1
(43) Pub. Date: May 9, 2019

(54) DISPLAY DEVICE

(71) Applicant: NIPPON SEIKI CO., LTD., Niigata (JP)

(72) Inventors: Toshio TSUKAMOTO, Niigata (JP); Yuki MASUYA, Niigata (JP); Takeshi YACHIDA, Niigata (JP)

(21) Appl. No.: 16/099,948

(22) PCT Filed: May 8, 2017
(86) PCT No.: PCT/JP2017/017420

§ 371 Date: Nov. 8, 2018

(30) Foreign Application Priority Data
May 16, 2016 (JP) 2016-097828

(51) Int. Cl. G02B 27/01; G06F 3/147; G06F 3/16

(52) U.S. Cl. CPC G02B 27/0101; B60K 35/00; G06F 3/165; G06F 3/147

(57) ABSTRACT

Provided is a display device which can quickly start displaying images while preventing deterioration of a display means. A display device is mounted on a conveyance, such as a vehicle, and causes the display light emitted by a display means to reflect off a reflecting member (such as a concave mirror) onto a translucent member (such as a windshield) so that the image displayed by the display light can be visually recognized. The display means comprises a drive control means (such as a control means and a drive means) which moves the reflecting member between a first position (such as a displayable position) where it is possible to visually identify the image and a second position (such as a park position) where it is more difficult to visually identify the image than in the first position. The drive control means moves the reflecting member from the second position to the first position upon obtaining a boarding prediction signal (such as a door state signal showing the door lock or open state of the vehicle) showing the contents of prediction of boarding the conveyance.

### TECHNICAL FIELD

The present invention relates to a display device.

### BACKGROUND ART

PTL 1 discloses a display device (which is called head-up display; hereinafter also referred to as “HUD (Head-Up Display) device”) which is mounted on a vehicle or the like, and causes display light emitted by a display means to be reflected by a reflecting member (such as a concave mirror) and then projected onto a translucent member (such as a windshield of a vehicle), thereby causing an image displayed by the display light to be visually recognized. The HUD device is configured such that the display position of the image can be adjusted by driving the reflecting member with a motor.

### CITATION LIST

### Patent Literature

PTL 1: JP-A-2015-208195

### SUMMARY OF INVENTION

### Technical Problem

In the HUD device configured as described in PTL 1, in order to prevent deterioration of the display means (such as a liquid crystal display) due to the incidence of external light, the reflecting member is moved to a position where the image cannot be visually recognized when the device is not in use and the reflecting member is moved to a displayable position where the image can be visually recognized at the time of starting using the device (such as at the time of ignition on of a vehicle). However, in this method, the image display is delayed for at least the period of time from the start of use of the device to the time when the reflecting member moves to the displayable position.

The invention has been made in view of the above circumstances, and an object is to provide a display device capable of quickly starting image display while preventing deterioration of a display means.

### Solution to Problem

In order to achieve the above object, the display device according to the invention is

a display device which is mounted on a conveyance and causes display light emitted by a display means to be reflected by a reflecting member and then projected onto a translucent member, thereby causing an image displayed by the display light to be visually recognized, wherein

the display device includes a drive control means which moves the reflecting member between a first position at which the image is capable of being visually recognized and a second position at which the image is more difficult to be visually recognized as compared to the case of the first position,

and the drive control means moves the reflecting member from the second position to the first position upon obtaining a boarding prediction signal indicating a content of prediction of boarding the conveyance.

### Advantageous Effects of Invention

According to the invention, it is possible to quickly start image display while preventing the deterioration of the display means.

### BRIEF DESCRIPTION OF DRAWINGS

FIG. 1 is a block diagram showing a display device according to an embodiment of the invention.

FIG. 2 is a diagram showing a mounting mode of the display device according to the embodiment of the invention on a vehicle.

FIG. 3 is a schematic configuration structural diagram of the display device according to the embodiment of the invention.

FIG. 4 is a flowchart of a display preparation processing according to the embodiment of the invention.

### DESCRIPTION OF EMBODIMENTS

A display device according to an embodiment of the invention will be described with reference to the drawings.

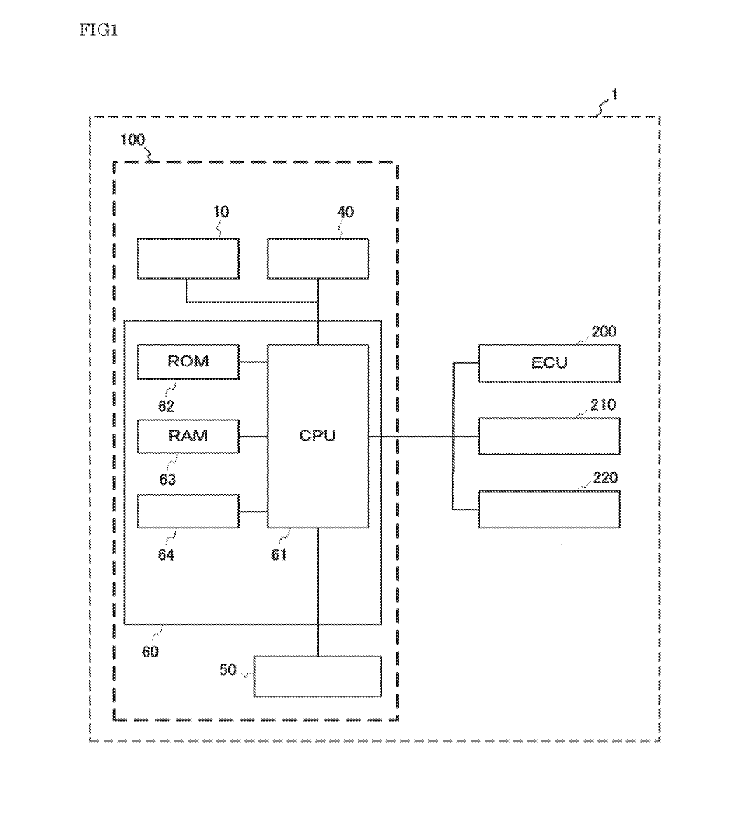

As shown in FIG. 1, a display device 100 according to the present embodiment is mounted on a vehicle 1 (for example, installed in an instrument panel) and displays various information (hereinafter referred to as vehicle information) relating to the vehicle 1 by communicating with an ECU (Electronic Control Unit) 200 and the like. The vehicle information includes not only the information of the vehicle 1 itself but also external information of the vehicle 1.

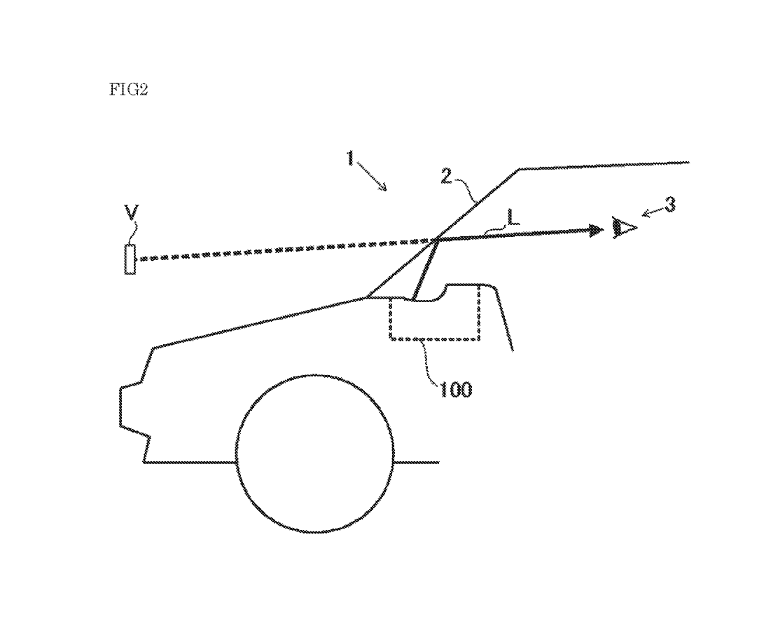

As shown in FIG. 2, the display device 100 is configured as a head-up display (HUD device) which displays an image represented by a display light L as a virtual image V in front of a windshield 2 by projecting the display light L on the windshield 2 (front glass) of the vehicle 1. The image visually recognized as the virtual image V is for notifying the vehicle information. In this way, a user 3 (mainly a driver of the vehicle 1) can visually recognize the vehicle information displayed overlapping with the scenery seen through the windshield 2.

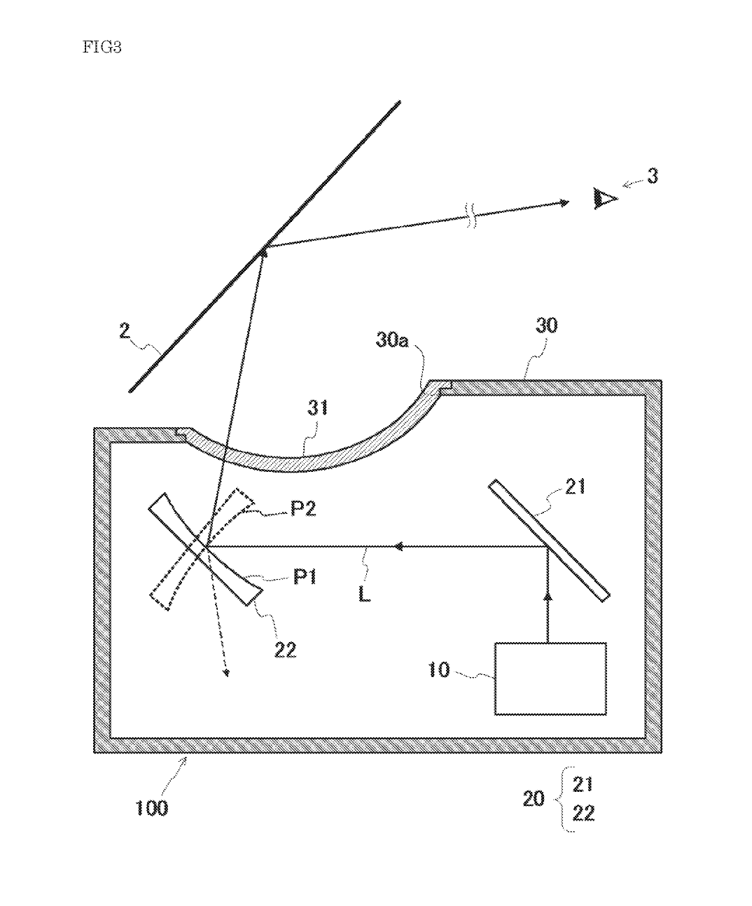

As shown in FIG. 1 and FIG. 3, the display device 100 includes a display means 10, a reflecting means 20, a case 30, a drive means 40, a temperature detection means 50 and a control means 60.

The display means 10 displays an image for notifying the vehicle information under the control of the control means 60. The display means 10 includes a liquid crystal display (LCD: Liquid Crystal Display), a backlight which illuminates the LCD from behind, and the like. The display means 10 displays the image towards a plane mirror 21 (see FIG. 3). In this way, the display light L representing the image is emitted towards the plane mirror 21. The display means 10 may be composed with an organic EL (Electro-Luminescence) display, a DMD (Digital Micromirror Device), a reflective and transmissive LCOS (registered trademark: Liquid Crystal On Silicon), or the like.

The reflecting means 20 includes the plane mirror 21 and a concave mirror 22. The plane mirror 21 is made with, for example, a cold mirror, and reflects the display light L from the display means 10 to the concave mirror 22.

The concave mirror 22 (an example of a reflecting member) reflects the display light L emitted from the display means 10 and reflected by the plane mirror 2 to the windshield 2 while enlarging the display light L. As a result, the virtual image V visually recognized by the user 3 becomes an enlarged image of the image displayed by the display means 10.

In the embodiment, the reflecting means 20 including two mirrors is exemplified. However, the reflecting means 20 may include one mirror, or three or more mirrors.

The case 30 houses the display means 10, the reflecting means 20, the drive means 40, the temperature detection means 50 and the control means 60 at appropriate positions. At least a part of the functions of the temperature detection means 50 and the control means 60 may be realized outside the case 30. The case 30 is formed with a synthetic resin or a metal in a box shape having light shielding property. The case 30 is provided with an opening 30a which secures an optical path of the display light L. A translucent cover 31 is attached to the case 30 so as to close the opening 30a. The translucent cover 31 is formed with a translucent resin such as acrylic.

The display light L reflected by the concave mirror 22 passes through the translucent cover 31 and heads towards the windshield 2. In this way, the display light L is emitted from the display device 100 towards the windshield 2. As the display light L is reflected by the windshield 2 towards the user 3, the virtual image V is displayed in front of the windshield 2 as viewed from the user 3. In addition, the concave mirror 22 is provided so as to be rotationally movable by the drive means 40.

The drive means 40 includes a motor (such as a stepping motor), a motor driver, a supporting part which supports the concave mirror 22 such that the concave mirror 22 is rotatable, a gear mechanism which transmits the rotary power of the motor to the concave mirror 22, and the like. Based on control signals from the control means 60, the drive means 40 causes the concave mirror 22 to rotate clockwise and/or counterclockwise in FIG. 3 around a rotation shaft not shown in the drawing, thereby changing the optical path of the display light L. The drive means 40 is provided for adjusting the display position of the virtual image V, and preventing the external light from being reflected towards the display means 10 when the display device 100 is not in use (that is, preventing deterioration of the display means 10), etc.

The drive means 40 can drive (move) the concave mirror 22 within a movable range including a displayable position P1 (see FIG. 3) and a park position P2 (see FIG. 3) under the control of the control means 60.

The “displayable position P1” is a position of the concave mirror 22 which enables the user 3 to visually recognize the display light L as the virtual image V, and is an example of the “first position” in the claims.

The “park position P2” is a position of the concave mirror 22 which disables the user 3 from visually recognizing the display light L as the virtual image V, and is an example of the “second position” in the claims. When the system of the display device 100 is shut down, the power supply is turned off after the concave mirror 22 moves to the park position P2 by the drive means 40. As the park position P2, a position which makes it impossible to visually recognize the virtual image V is preferable from the viewpoint of prevention of deterioration of the display means 10. However, it is not limited thereto. The park position P2 may be any position as long as it is a position at which the virtual image V is more difficult to be visually recognized as compared to the case of the displayable position P1 (that is, a position at which the external light is more difficult to reach the display means 10 as compared to the case of the displayable position P1) and is arbitrary in accordance with the design.

In the embodiment, the displayable position P1 and the park position P2 indicate positions (rotation positions) in the rotational movement of the concave mirror 22. However, they are not limited thereto. It may also be configured such that the optical path of the display light L is changed by moving the concave mirror 22 in parallel by the drive means 40. In this case, the displayable position P1 and the park position P2 are positions (parallel positions) in the parallel movement of the concave mirror 22.

A position detection means (not shown) detecting the position of the concave mirror 22 is provided in the display device 100, and the control means 60 can identify the current position of the concave mirror 22 according to a detection signal from the position detection means. The position detection means is, for example, a mechanical switch, a photosensor, a means which detects the rotation angle of the motor or the counter electromotive force, etc., and its configuration is arbitrary as long as the position of the concave mirror 22 can be detected.

In the embodiment, the park position P2 is, for example, defined as the origin position of the concave mirror 22 (reference position for movement control). However, as described above, the park position P2 is not limited thereto as long as it is a position which makes the visual recognition of the virtual image V more difficult as compared to the case of the displayable position P1.

Returning to FIG. 1, the temperature detection means 50 detects the temperature of the display means 10, and is made with, for example, a thermistor. The temperature detection means 50 outputs to the control means 60 a detection signal indicating the temperature of the display means 10, or indicating the temperature of the environment in which the display means 10 is placed. The temperature detection means 50 may be configured with a photosensor (such as a photodiode) which detects the intensity of the incident external light, and it can estimate the temperature of the display means 10 from the light intensity. In this case, a detection signal indicating the intensity of the external light is output to the control means 60, and the control means 60 which has obtained the detection signal may obtain the temperature of the display means 10 with reference to a table prepared in advance (a temperature identification table in which external light intensity and temperature are associated with each other).

In any of these methods, the control means 60 can obtain temperature information indicating the temperature of the display means 10 based on the detection signal from the temperature detection means 50. The temperature indicated by the temperature information is one of the parameters in whether permitting or not the drive of the concave mirror 22 in a “display preparation processing” which will be described later.

The temperature that can be identified based on the detection signal from the temperature detection means 50 may be any one as long as it can be used as a determination criterion for suppressing deterioration of the display means 10 and occurrence of abnormal operation due to high temperatures, and it may be a temperature of a predetermined portion of the display means 10, or the ambient temperature in the case 30. In other words, the installation place of the temperature detection means 50 is arbitrary as long as such temperature can be identified. The temperature detection means 50 may be provided directly in the display means 10 or in the vicinity of the display means 10, or it may be provided outside the display device 100.

The control means 60 controls the overall operation of the display device 100, and includes a CPU (Central Processing Unit) 61, a ROM (Read Only Memory) 62, a RAM (Random Access Memory) 63 and a video memory 64.

The ROM 62 stores an operation program (such as a program for executing the “display preparation processing” which will be described later) or fixed data (such as the above-described temperature identification table, and a table for drive permission determination which will be described later) in advance. In addition, “staying period information” indicating a staying period of the concave mirror 22 at the displayable position P1 at the time of the previous activation of the display device 100 is stored in the ROM 62. The staying period information is rewritten to the latest information, for example, when the display device 100 is powered off, etc.

The RAM 63 temporarily stores various calculation results and the like. For example, data and the like indicating a determination result or a decision result in the display preparation processing which will be described later are stored in the RAM 63. In addition, a flag setting section is provided in the RAM 63, and data indicating the on state or off state of the flag and data indicating the value of the flag are stored in the RAM 63 for each of a plurality of kinds of flags (such as a permission flag and a display-available flag which will be described later).

The video memory 64 is composed with a HDD (Hard Disk Drive), a flash memory or the like, and stores data of image (image data) to be displayed on the display means 10.

Operating power is supplied to the control means 60 from a power supply (not shown) connected to the display device 100. The “display preparation processing” which will be described later is executable when ignition is off and the ACC (accessory) power supply is turned off, and the control means 60 is activated under predetermined conditions which will be described later. In addition, the drive control of the display means 10 is executable as the ignition, the ACC power supply and the like are turned on.

The control means 60 is configured to be capable of inputting and outputting various signals via an I/F (InterFace) with an external device such as the ECU 200, an external display means 210, a speaker 220 and the like which will be described later. In addition, at least a part of the control means 60 may be constituted by a dedicated circuit such as an ASIC (Application Specific Integrated Circuit).

The CPU 61 executes processing for controlling the overall operation of the display device 100 using the operation program or fixed data read from the ROM 62. In this case, a fixed data reading operation in which the CPU 61 reads the fixed data from the ROM 62, a data writing operation in which the CPU 61 writes various data into the RAM 63 to temporarily store the data, a data reading operation in which the CPU 61 reads various data temporarily stored in the RAM 63, a reception operation in which the CPU 61 receives input of various signals from the outside of the control means 60 via the I/F, a transmission operation in which the CPU 61 outputs various signals to the outside of the control means 60 via the I/F, and the like are also performed. In addition, the CPU 61 appropriately conducts timing with a built-in timer.

The CPU 61 performs display control of the display means 10 via a display control section (graphic controller) which is not shown in the drawing based on image data stored in the video memory 64. The display control section determines the control content of the display operation in the display means 10 based on a display control command from the CPU 61. For example, the display control section performs control for executing various kinds of displays by determining the switching timing of the images to be displayed on a display screen of the display means 10.

Here, the control between the control means 60 and the system (the ECU 200, the external display means 210, and the speaker 220) in the vehicle 1 will be described with reference to FIG. 1.

The ECU 200 controls each part of the vehicle 1 and outputs detection signals corresponding to the detections of various sensors provided in the vehicle 1 to the control means 60. The control means 60 obtains a “boarding prediction signal” and an “activation prediction signal” used in the display preparation processing which will be described later from the ECU 200 by CAN (Controller Area Network) communication or the like.

The “boarding prediction signal” is a signal indicating a content of prediction of boarding of the user 3 to the vehicle 1, and is, for example, a door state signal indicating a door lock or a door open of the vehicle 1.

The “activation prediction signal” is a signal indicating a content of prediction of the activation (ignition on) of the system of the vehicle 1, and includes, for example, an accessory signal indicating that the ACC power supply is turned on, a seat belt signal indicating that a seat belt has been fastened, a seat position signal indicating that a seat (for example, a driver's seat) has been adjusted, a side brake release signal indicating that a side brake has been released, and the like.

Both the boarding prediction signal and the activation prediction signal are not limited to the signals obtainable via the ECU 200, and the types thereof are not limited to those exemplified above.

For example, the boarding prediction signal may be a signal indicating that a smart key or a smartphone capable of wirelessly communicating with the system of the vehicle 1 has entered an area where the communication is possible, or a signal indicating that the position of the user 3 relative to the vehicle 1 falls within a predetermined distance (for example, in a case where a GPS (Global Positioning System) unit is provided in the vehicle 1 and the user 3 carries a smartphone or the like, and the position of the vehicle 1 and the position of the user 3 can be detected), or the like.

In addition, the activation prediction signal may be a signal when it is detected that the user 3 has boarded (or the user 3 has been seated) based on an image captured by an imaging means provided in the vehicle 1 (for example, detectable by image analysis by a pattern matching method), or a signal when the seating of the user 3 is detected by a weight sensor provided in the seat of the vehicle 1, or the like.

The control means 60 obtains an ignition signal indicating the state of the ignition (on state or off state) of the vehicle 1 from the ECU 200.

The control means 100 executes, under a predetermined condition which will be described later, a notification processing by image or audio that display of an image (image visually recognized by the user 3 as the virtual image V) by the display device 100 (the display means 10) is currently unavailable by driving and controlling at least one of the external display means 210 and the speaker 220.

In the case of notifying by image, it is not limited to indicating by a sentence such as “Display is currently unavailable” that currently display is not possible. It may also indicate by a sentence such as “Please wait for a while till display starts” that it takes time for the display to start. In addition, notification may be performed using images indicating icons and the like instead of letters. The notification by image is only necessary to include at least one selected from letters, figures, icons and the like.

In the case of notifying by audio, it may be notified by reading out a sentence which is recognizable that currently display is not possible or that it takes time for the display to start, or may be notified with a warning sound (buzzer sound) or the like.

The external display means 210 is an image display device provided in advance in the vehicle 1 different from the display means 10, and is, for example, a car navigation device or a digital display section in a combination meter.

The speaker 220 is, for example, any speaker (meter speaker, buzzer, audio speaker, etc.) provided in advance in the vehicle 1. The speaker may also be provided in the display device 100.

The external display means 210 and the speaker 220 are not limited to those provided in advance in the vehicle 1. For example, the external display means 210 and the speaker 220 may be realized by a display and a speaker of a mobile terminal (such as a smartphone) capable of communicating with the control means 60 wirelessly or via wire.

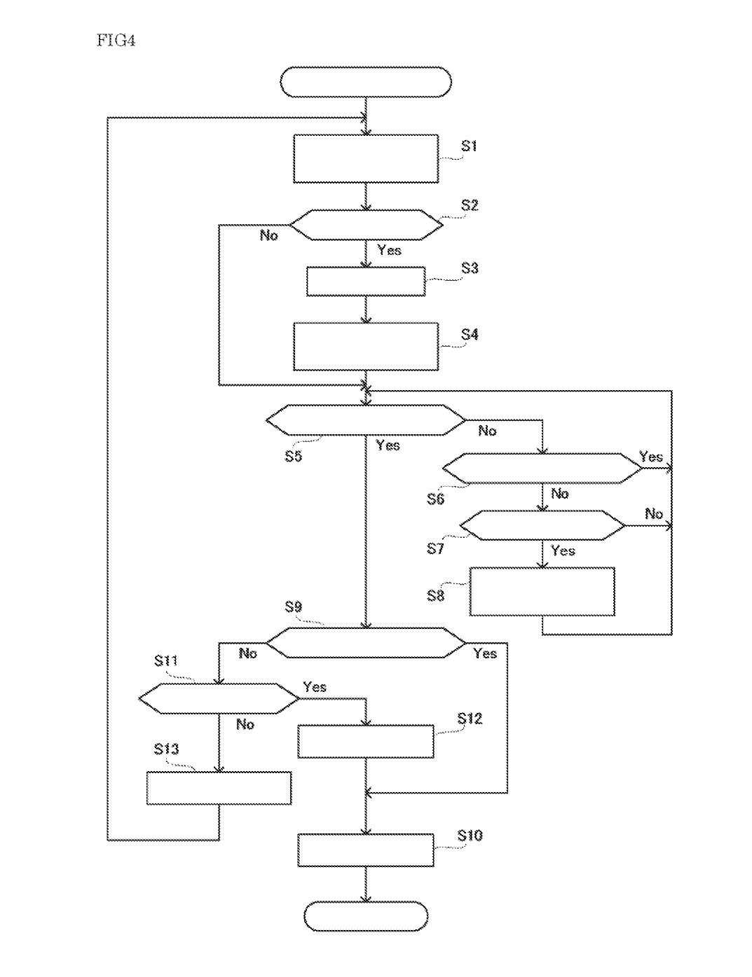

The configurations of the display device 100 and the other systems in the vehicle 1 have been described above. Next, the display preparation processing peculiar to the embodiment will be described with reference to the flowchart of FIG. 4.

### (Display Preparation Processing)

The CPU 61 executes the display preparation processing in response to acquisition of the aforementioned “boarding prediction signal” from the ECU 200, for example. The control means 60 can monitor the presence or absence of the boarding prediction signal and can be activated even when the ignition is off and the ACC power supply is turned off. Since the start of the display preparation processing is after the previous shutdown, the concave mirror 22 is positioned at the “park position P2”.

First, the CPU 61 obtains the temperature information from the temperature detection means 50 while reading the staying period information stored in the ROM 62 (step S). As described above, the staying period information indicates the staying period of the concave mirror 22 at the displayable position P1 at the time of the previous activation.

Then the CPU 61 determines whether or not to permit the drive of the concave mirror 22 based on the information obtained in step S1 (step S2). For example, the CPU 61 decides the determination result with reference to a table for drive permission determination stored in advance in the ROM 62.

The table for drive permission determination is configured, for example, by associating a combination of each parameter of the staying period information and the temperature information with a determination result (whether or not the drive is permitted). The table for drive permission determination is configured such that, when the staying period is longer than a certain threshold value or the temperature is higher than a certain threshold value, it is not preferable from the viewpoint of protecting the display means 10, and thus it is determined that the drive is not permitted. With reference to such a table for drive permission determination, the CPU 61 decides a determination result corresponding to a combination of each parameter of the staying period information and the temperature information obtained from the ECU 200. It is not necessary to use all of the parameters in the table for drive permission determination. It is only necessary to use at least one of the staying period information and the temperature information.

When it is determined that the drive of the concave mirror 22 is permitted (step S2; Yes), the CPU 61 sets a permission flag to the on state (step S3) and controls the drive means 40 to move the concave mirror 22 from the “park position P2” to the “displayable position P1” (step S4). When the movement of the concave mirror 22 to the displayable position P1 is completed, a display-available flag is set to the on state.

When it is determined that the drive of the concave mirror 22 is not permitted (step S2; No), or, after the execution of the processing of step S4, the CPU 61 determines whether or not the ignition of the vehicle 1 is in the on state (step S5). It is determined whether or not the ignition is in the on state based on the aforementioned ignition signal.

When the ignition is in the off state (step S5; No), the CPU 61 determines whether there is an input of the aforementioned “activation prediction signal” or not (step S6).

When there is no input of the activation prediction signal (step S6; No), the CPU 61 determines whether or not a predetermined period has elapsed (step S7) based on the timer which started timing with the start of the display preparation processing, for example.

When the predetermined period has elapsed (step S7; Yes), the CPU 61 controls the drive means to move the concave mirror 22 to the park position P2 and clears the display-available flag to the off state (step S8). When the concave mirror 22 is at the park position P2 (that is, when the drive was not permitted in step S2), the drive control of the concave mirror 22 is not performed and the process stands by in the processing of step S5.

When there is an input of the activation prediction signal in step S6 (step S6; Yes), or when the predetermined period has not elapsed in step S7 (step S7; No), or after the execution of the processing of step S8, the process returns to the processing of step S5.

That is, the processing in steps S6 to S8 is a processing for, when there is no input of the activation prediction signal within a predetermined period (for example, within several tens of seconds or within several minutes), deeming that there is no intention to activate the system of the vehicle 1 for the moment although the user 3 has boarded the vehicle 1, and returning the concave mirror 22, which has been moved to the displayable position P1 in advance so as to quickly start the image display, to the park position P2 again. In this way, it is possible to protect the display means 10 from external light when the probability of using the display device 100 is low.

When the ignition is in the on state in step S5 (step S5; Yes), the CPU 61 determines whether or not the display-available flag is in the on state (that is, whether the concave mirror 22 is at the displayable position P1) (step S9). When the display-available flag is in the on state (step S9; Yes), the CPU 61 starts the image display (step S10) and the display preparation processing is ended. Thereafter, a general image control processing for displaying the virtual image V with the display light L is executed.

When the display-available flag is in the off state in step S9 (step S9; No), the CPU 61 determines whether the permission flag is in the on state (step S11).

When the permission flag is in the on state (step S11; Yes), it is equivalent to the case where the drive is permitted and the concave mirror 22 has once moved to the displayable position P1 (Yes in step S2, and then steps S3 and S4) and in step S8, the concave mirror 22 has returned to the park position P2. Therefore, the image display is started immediately (step S10) after the CPU 61 controls the drive means 40 and moves the concave mirror 22 to the displayable position P1 (step S12).

When the permission flag is in the off state (step S11; No), the CPU 61 executes the notification processing to notify that the image display is currently unavailable (step S13) and returns the processing to step S1. The notification mode here may be any as long as it uses at least one of the notification by image on the external display means 210 and the notification by audio on the speaker 220 as described above.

In the case where the display control by the display means 10 is possible while the ACC power supply is on, when the activation prediction signal obtained in step S8 is an accessory signal indicating that the ACC power supply has been turned on, the processing from step S9 onward may be executed without going through step S5.

The invention is not limited by the above-described embodiments and drawings. Modifications (including deletions of constituent elements) may be appropriately added as long as the point of the invention is not changed.

The projection object of the display light L is not limited to the windshield 2, and it may be a combiner (another example of the translucent member) composed with a plate-shaped half mirror, a hologram element, etc.

In addition, the display device 100 is not limited to being mounted on the vehicle 1 as an automatic four-wheeled vehicle as exemplified. The display device 100 may be mounted on other vehicles such as a motorcycle, or conveyance other than vehicles, such as a water bike, a snow bike, a ship and an aircraft.

The aforementioned operation program is stored in the ROM 62 in advance. However, the operation program may be distributed and/or provided with a detachable recording medium. The operation program may also be downloaded from another device connected to the display device 100. In addition, the display device 100 may execute various processing according to the operation program by exchanging various data with other devices via a telecommunication network or the like.

(1) The display device described above (for example, the display device 100) is a display device which is mounted on a conveyance (for example, the vehicle 1) and causes display light (display light L) emitted by a display means (for example, the display means 10) to be reflected by a reflecting member (for example, the concave mirror 22) and then projected onto a translucent member (for example, the windshield 2), thereby causing an image displayed by the display light to be visually recognized, wherein

the display device includes a drive control means (for example, the control means 60, the drive means 40) which moves the reflecting member between a first position (for example, the displayable position P1) at which the image is capable of being visually recognized and a second position (for example, the park position P2) at which the image is more difficult to be visually recognized as compared to the case of the first position,

the drive control means moves the reflecting member from the second position to the first position upon obtaining a boarding prediction signal indicating a content of prediction of boarding the conveyance (for example, the control means 60 executes the processing of step S4, etc.).

In this way, it is possible to quickly start image display while preventing deterioration of the display means. Moreover, by appropriately having the following configurations of (2) to (6), it is possible to prevent deterioration of the display means more satisfactorily.

(2) The display device according to (1) may be configured such that

after moving the reflecting member to the first position, the drive control means returns the reflecting member to the second position when the drive control means cannot obtain an activation prediction signal indicating a content of prediction of the activation of the display means even after a lapse of a predetermined period (for example, the control means 60 executes the processing from step S6 to step S8, etc.).

(3) The display device according to (1) or (2) may be configured such that

the display device includes a storage means (for example, the ROM 62) which stores staying period information indicating a staying period of the reflecting member at the first position,

the drive control means determines whether or not to permit drive of the reflecting member based on at least one of the staying period information stored in the storage means and obtained temperature information of the display means, and when it is determined that the drive of the reflecting member is not permitted, the drive control means does not drive the reflecting member even if the boarding prediction signal is obtained (for example, the control means 60 does not perform the processing of step S4 when it is No in step S2).

(4) The display device according to (3) may be configured such that

when the display means is activated, the drive control means moves the reflecting member to the first position even when it is determined that the drive of the reflecting member is not permitted (for example, the control means 60 may execute the processing of step S12 when it is Yes in step S5 even though it is No in the processing of step S2).

(5) The display device according to (3) or (4) may include

a display control means (for example, the control means 60 which executes the processing of step S13) which is capable of causing an image indicating that display of the image is currently unavailable to be displayed on an external display means (for example, the external display means 210) when the drive control means determines that the drive of the reflecting member is not permitted.

(6) The display device according to any one of (3) to (5) may include

an audio control means (for example, the control means 60 which executes the processing of step S13) which is capable of causing an audio indicating that display of the image is currently unavailable to be output to a speaker (for example, the speaker 220) when the drive control means determines that the drive of the reflecting member is not permitted.

In particular, according to the configurations of (5) and (6) above, when image display is unavailable, it is possible to notify this fact, and thus it is user-friendly.

In the above description, descriptions of well-known technical matters have been appropriately omitted for a better understanding of the invention.

### INDUSTRIAL APPLICABILITY

The invention relates to a display device, and it can be applied as a display device mounted on, for example, an automobile or a motorcycle, or a mobile body equipped with an agricultural machine or a construction machine.

### REFERENCE SIGNS LIST

1: vehicle, 2: windshield, 3: user, L: display light, V: virtual image
100: display device
10: display means
20: reflecting means, 21: plane mirror, 22: concave mirror (an example of reflecting member)
P1: displayable position (an example of first position),
P2: park position (an example of second position)
30: case
40: drive means
50: temperature detection means
60: control means, 61: CPU, 62: ROM
200: ECU, 210: external display means, 220: speaker

1. A display device which is mounted on a conveyance and causes display light emitted by a display means to be reflected by a reflecting member and then projected onto a translucent member, thereby causing an image displayed by the display light to be visually recognized, wherein
the display device comprises a drive control means which moves the reflecting member between a first position at which the image is capable of being visually recognized and a second position at which the image is more difficult to be visually recognized as compared to the case of the first position,
the drive control means moves the reflecting member from the second position to the first position upon obtaining a boarding prediction signal indicating a content of prediction of boarding the conveyance.

2. The display device according to claim 1, wherein
after moving the reflecting member to the first position, the drive control means returns the reflecting member to the second position when the drive control means cannot obtain an activation prediction signal indicating a content of prediction of the activation of the display means even after a lapse of a predetermined period.

3. The display device according to claim 1, wherein
the display device further comprises a storage means which stores staying period information indicating a staying period of the reflecting member at the first position,
the drive control means determines whether or not to permit drive of the reflecting member based on at least one of the staying period information stored in the storage means and obtained temperature information of the display means, and when it is determined that the drive of the reflecting member is not permitted, the drive control means does not drive the reflecting member even if the boarding prediction signal is obtained.

4. The display device according to claim 3, wherein
when the display means is activated, the drive control means moves the reflecting member to the first position even when it is determined that the drive of the reflecting member is not permitted.

5. The display device according to claim 3, wherein
the display device further comprises a display control means which is capable of causing an image indicating that display of the image is currently unavailable to be displayed on an external display means when the drive control means determines that the drive of the reflecting member is not permitted.

6. The display device according to claim 3, wherein
the display device further comprises an audio control means which is capable of causing an audio indicating that display of the image is currently unavailable to be output to a speaker when the drive control means determines that the drive of the reflecting member is not permitted.

7. The display device according to claim 2, wherein
the display device further comprises a storage means which stores staying period information indicating a staying period of the reflecting member at the first position,
the drive control means determines whether or not to permit drive of the reflecting member based on at least one of the staying period information stored in the storage means and obtained temperature information of the display means, and when it is determined that the drive of the reflecting member is not permitted, the drive control means does not drive the reflecting member even if the boarding prediction signal is obtained.
